(19) United States
(12) Patent Application Publication
(10) Pub. No.: US 2007/0140234 A1
(43) Pub. Date: Jun. 21, 2007

(54) SIGNAL TRANSMISSION HOUSING ASSEMBLY

(76) Inventors: Shih-Ming HWANG, Irvine, CA (US); Chien-Jong HWANG, Irvine, CA (US); Liang-Lun HWANG, Irvine, CA (US)

Correspondence Address: PAI PATENT & TRADEMARK LAW FIRM, 1001 FOURTH AVENUE, SUITE 3200, SEATTLE, WA, 98154, US

(21) Appl. No.: 11/306,082

(22) Filed: Dec. 15, 2005

(51) Int. Cl. H04L 12/56

(52) U.S. Cl. 370/389

(57) ABSTRACT

A signal transmission housing assembly is formed of a plurality of longitudinally interconnected signal transmission housings, wherein the casing of each individual signal transmission housing has a closed bottom plate and four closed surrounding wall plates, and an detachable top plate so as to form a chamber therein. An insertion member and a corresponding slide guide member are respectively provided on outer surfaces of two transverse wall plates of the casing of the signal transmission housing for coupling with adjacent signal transmission housings. A plurality of holes are formed on the top plate. In this fashion, the signal transmission housing assembly can be constructed by coupling two or more individual signal transmission housings to house the required signal transmission equipment in a neat and orderly manner that is convenient for installation, operation, and maintenance.

### BACKGROUND OF THE INVENTION

1. Field of the Invention

The present invention relates to a signal transmission housing, and in particular, to a plurality of individual signal transmission housings that can be interlocked to form into a signal transmission housing assembly so as to facilitate the installation, operation, and maintenance of such signal transmission housing assemblies.

2. Description of the Prior Art

The essential object of a signal transmission housing is to house one or more pieces of signal transmission equipment such as push button switches, terminal connectors, and video transmission wires. In a conventional video security monitoring system, for instance, pictures taken by a surveillance camera are received by signal transmission equipment installed inside a signal transmission housing and then retransmitted to a surveillance terminal for display or archiving.

The conventional housing for signal transmission equipment on the present market only serves for installing one type of signal transmission equipment. Such a simple design is insufficient for use with complicated modern video monitoring systems in which a plurality of surveillance cameras are installed to catch photos from different directions. Accordingly, a number of signal transmission housings are required for multiple surveillance cameras. For the convenience of installation and maintenance, it would be desirable for a plurality of signal transmission housings to be grouped in one place in an organized fashion by interlocking their housings side-by-side. This would help avoid the tangling and twisting of signal wires that can affect the operation of signal transmission equipment and make installation and maintenance work difficult.

For the deficiency noticed on the present conventional housing for signal transmission equipment, an improvement is urgently required. The inventor has dedicated great efforts for years to study and rectify this deficiency, and has finally come up with a novel signal transmission housing assembly as described in this invention to compensate for the deficiency mentioned above.

### SUMMARY OF THE INVENTION

Accordingly, the main object of the present invention is to provide a convenient signal transmission housing assembly in which a plurality of individual signal transmission housings can be interlocked to form a concentrated group of multiple signal transmission housings so as to facilitate installation, operation, and maintenance.

To achieve the above objective, the present invention provides a signal transmission housing design capable of interlocking multiple signal transmission housings side-by-side, wherein the external casing of each individual signal transmission housing has a closed bottom plate and four closed surrounding wall plates and a detachable top plate so as to form a chamber in the casing. A locking mechanism, consisting of an insertion member on one of said wall plates and a slide guide member on a wall plate opposite said wall plate, are provided on each of said signal transmission housings. Said insertion member of one signal transmission housing can be inserted into a slide guide member of another signal transmission housing in such a way as to lock multiple signal transmission housings into a single, easy-to-install unit. A plurality of holes are formed on the top plate.

In such a fashion, multiple signal transmission housings can be linked and interconnected to form a signal transmission housing assembly in a neat and orderly manner convenient for installation, operation, and maintenance.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of a signal transmission housing assembly of the present invention.

FIG. 2 is a three-dimensional exploded view of a signal transmission housing assembly of the present invention.

FIG. 3 is a three-dimensional view of an embodiment of the present invention with only one signal transmission housing.

FIG. 4 is a three-dimensional view of an embodiment of the present invention with two signal transmission housings.

### DETAILED DESCRIPTION OF THE PREFERRED EMBODIMENT

A preferred embodiment of the signal transmission housing assembly of the present invention will be described in detail hereinafter with reference to the accompanying drawings.

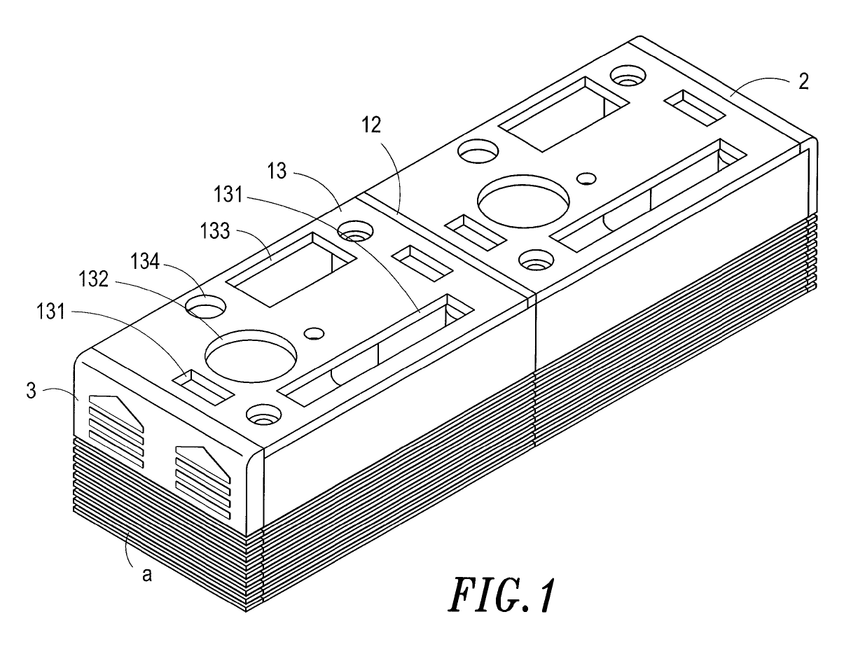

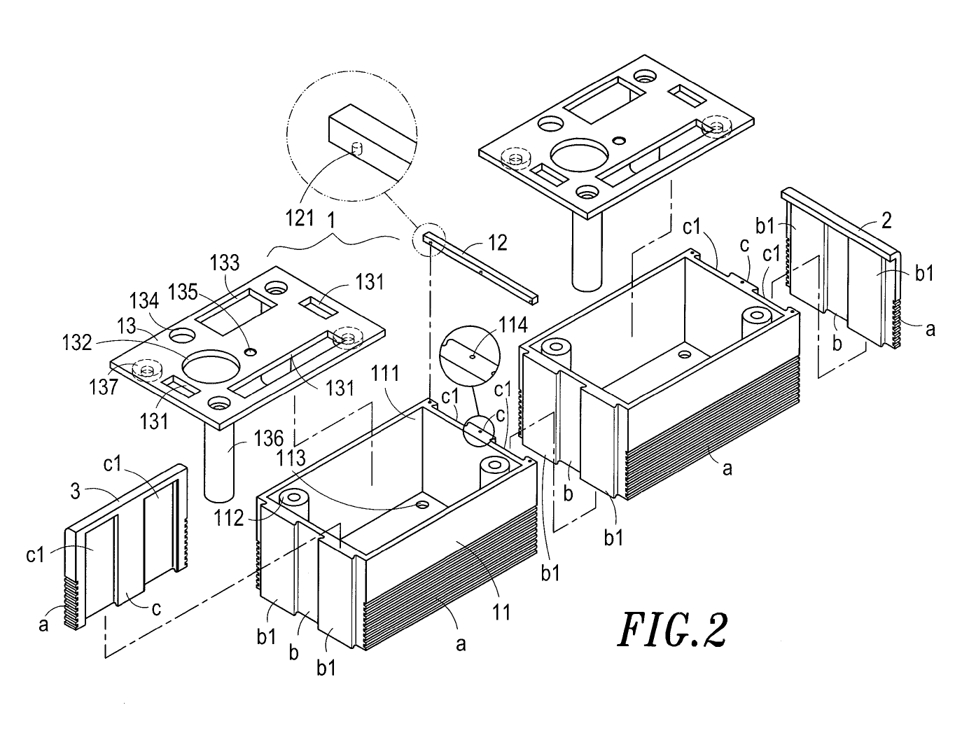

Referring to FIG. 1 and 2, the signal transmission housing assembly of the present invention is composed of a plurality of interconnected signal transmission housings 1, a first barrier plate 2 and a second barrier plate 3.

A casing 11 of each individual signal transmission housing 1 has a closed bottom plate and four closed surrounding wall plates, and a detachable top plate 13. The outer surface of said surrounding wall plates is provided with skid-proof creases a, and the inner part of the casing 11 is formed into a hollow chamber 111 to house signal transmission equipment. There are two diagonally opposed second internally threaded hollow cylinders 112 upwardly erected from two bottom corners of the casing 11 for a bolt to pass through, and two first screw holes 113 are provided on the other two corners thereof. Two wall plates in connection with two adjacent housings are respectively provided with an insertion member b with two slide blocks b1, and a corresponding slide guide member c with two recessed slide guides c1. A plurality of mortises 114 are formed on the top edge of the wall plates to mate the corresponding tenons 121 provided along the bottom of a pressing rod 12. The top plate 13 is provided with a plurality of holes including three connector receptacle outlets 131, a conductor passage hole 132, a switch base 133, and a signal wire passage hole 134. A pilot lamp 135 is installed on the top plate 13 to indicate the operation state of the signal transmission equipment. Moreover, two first internally threaded hollow cylinders 136 are extended downwardly from the top plate 13 in alignment with the first screw holes 113 to allow two screws or bolts to directly bolt the signal transmission housing to a building wall or other fixture or to the ground. On the other hand, the two second internally threaded hollow cylinders 112 and second screw holes 137 are for engaging the top plate 13 to the casing 11. The exact number of said holes, pilot lamps, internally threaded hollow cylinders, and screw holes, and their exact placement on or under the top plate 13, can be varied according to the need of the signal transmission equipment.

The first barrier plate 2 is installed at the front terminal of the first box 1 in the longitudinal direction, the inner side thereof is provided with the insertion member b corresponding to the slide guide member c formed on the casing 11 of said first box 1. Besides, the outer surface of said first barrier plate 2 is also provided with a skid-proof crease a.

The second barrier plate 3 is installed at the rear terminal of the last box 1, the inner side thereof is provided with the slide guide member c corresponding to the insertion member b formed on said last box 1; the outer surface of said second barrier plate 3 is also provided with a skid-proof creases a.

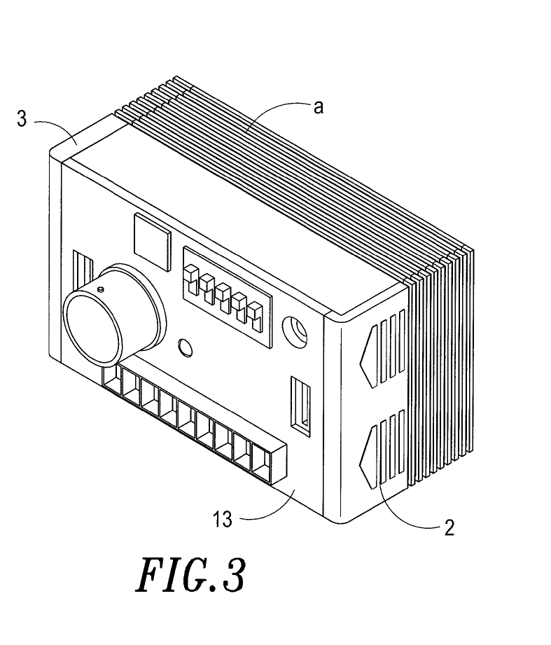

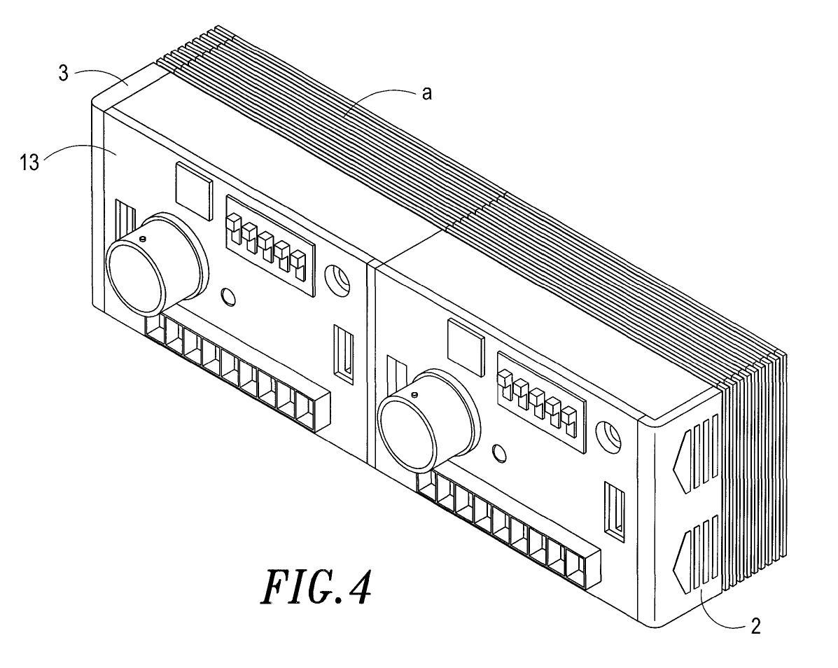

Referring to FIGS. 3 and 4, with such structure, multiple signal transmission housings 1 can be interconnected in series longitudinally as required by the surveillance system to transfer the monitoring signals from all directions. The connection of the casing 11 of one box 1 to that of another is performed by coupling the insertion member b of the antecedent box 1 with the slide guide member c of the following box 1 by inserting the two slide blocks b1 of the insertion member b formed on the former into the corresponding recessed slide guides c1 of the slide guide member c formed on the latter. After the connection is completed, two outer terminals of the assembly are closed respectively with the first barrier plate 2 and the second barrier plate 3. Afterwards, signal transmission equipment is installed in the chamber 111 of the individual boxes 1. The necessary connection of the component devices can be performed making use of the connector receptacles outlet 131, the conductor passage hole 132, the switch base 133, and the signal wire passage 134. The pilot lamp 135 installed on each top plate 13 of the individual signal transmission housing serves to indicate the operation state of the signal transmission equipment installed in that signal transmission housing. In this way, for instance, a surveillance system will be able to receive desired pictures taken by one or more cameras set in predetermined locations via the individual signal transmission housings 1 and display them at one or more remote display terminals.

It emerges from the above description that the present invention has several advantages, namely:

(1) Firm coupling of signal transmission housings into a concentrated signal transmission housing assembly enables the orderly and neat arrangement of signal transmission equipment convenient for installation, operation, and maintenance.

(2) The number of signal transmission housings that are coupled together can vary depending on the actual needs of the video monitoring system or other similar system.

(3) The entire surrounding wall surface of the signal transmission housing assembly, including the first and second (last) barrier plates, are provided with skid-proof creases to facilitate handling and maintenance.

Many changes and modifications to the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A signal transmission housing assembly comprising a plurality of longitudinally interconnected signal transmission housings, each of which comprises:
a casing having a closed bottom plate and four closed surrounding wall plates, and a detachable top plate so as to form a chamber in said casing,
wherein an insertion member and a corresponding slide guide member are respectively provided on the outer surfaces of two of said wall plates, and a plurality of holes are formed on said top plate,
wherein said signal transmission housing assembly is constructed by successively coupling the plurality of signal transmission housings through the insertion member and the corresponding slide guide member to house required signal transmission equipment in the chamber of said casing in a neat and orderly manner.

2. The signal transmission housing assembly of claim 1, wherein the first and the last terminal wall plates of said signal transmission housing assembly are respectively fitted with a first barrier plate and a second barrier plate, an insertion member being formed on one side of said first barrier plate to mate the corresponding slide guide member formed on said first terminal wall plate and a slide guide member being formed on one side of said second barrier plate to mate the corresponding insertion member formed on said last terminal wall plate.

3. The signal transmission housing assembly of claim 2, wherein said insertion member comprises two slide blocks, and said slide guide member comprises two recessed slide guides in correspondence with said two slide blocks, to allow the two slide blocks of one signal transmission housing to slide into the two recessed slide guides of an adjacent signal transmission housing.

4. The signal transmission housing assembly of claim 2, wherein the outer surface of said first barrier plate is provided with skid-proof creases.

5. The signal transmission housing assembly of claim 2, wherein the outer surface of said second barrier plate is provided with skid-proof creases.

6. The signal transmission housing assembly of claim 1, wherein said holes formed on said top plate are used to serve as outlets for at least a connector receptacle, a conductor passage, a switch base, and a signal wire passage.

7. The signal transmission housing assembly of claim 1, wherein a pilot lamp is installed on said top plate of said signal transmission housing.

8. The signal transmission housing assembly of claim 1, wherein at least one first screw hole is formed on a bottom corner of the casing of said signal transmission housing, and at least one downwardly extending first internally threaded hollow cylinder is provided to said top plate to pierce through said first screw hole to allow said signal transmission housing to be bolted onto a building wall or ground.

9. The signal transmission housing assembly of claim 1, wherein at least one upwardly erected second internally threaded hollow cylinder is provided on a bottom corner of the casing of said signal transmission housing, and at least one corresponding second screw hole is formed on said top plate in alignment with said second internally threaded hollow cylinder so as to engage said top plate with said casing.

10. The signal transmission housing assembly of claim 1, wherein a pressing rod is provided for one transverse wall plate of said signal transmission housing.

11. The signal transmission housing assembly of claim 8, wherein the upper edge of said wall plate having said pressing rod provided for it has a plurality of mortises to join with corresponding tenons formed downwardly along said pressing rod.

12. The signal transmission housing assembly of claim 1, wherein the outer surface of surrounding walls of said signal transmission housing is provided with skid-proof creases.

13. The signal transmission housing assembly of claim 1, wherein said insertion member comprises two slide blocks, and said slide guide member comprises two recessed slide guides in correspondence with said two slide blocks, to allow the two slide blocks of one signal transmission housing to slide into the two recessed slide guides of an adjacent signal transmission housing.
